(19) United States
(12) Patent Application Publication
(10) Pub. No.: US 2011/0291974 A1
(43) Pub. Date: Dec. 1, 2011

(54) METHOD AND APPARATUS FOR SUPPORTING INPUT FUNCTION WHEN TOUCH INTERFACE OF A TOUCHSCREEN-BASED DEVICE MALFUNCTIONS

(75) Inventors: Hyeon Seok SON, Gimcheon-si (KR); Hae Jun AN, Seongnam-si (KR); Jae Hyuk PARK, Suwon-si (KR)

(73) Assignee: SAMSUNG ELECTRONICS CO. LTD., Suwon-si (KR)

(21) Appl. No.: 13/118,755

(22) Filed: May 31, 2011

(30) Foreign Application Priority Data
Jun. 1, 2010 (KR) 10-2010-0051597

(51) Int. Cl. G06F 3/041

(52) U.S. Cl. 345/173

(57) ABSTRACT

A method and apparatus for supporting an input function to a touchscreen-based device when the touch interface malfunctions are provided. The input function supporting method includes detecting an input operation via a function key, determining, when the input operation is performed via the function key, an input manner of the input operation via the function key, changing, when the input manner of the input operation via the function key corresponds to a preset manner, a current mode to an emergency input mode, and processing a function, according to another input operation of the same or another function key, in the emergency input mode.

### PRIORITY

This application claims the benefit under 35 U.S.C. §119(a) of a Korean patent application filed on Jun. 1, 2010 in the Korean Intellectual Property Office and assigned Serial No. 10-2010-0051597, the entire disclosure of which is hereby incorporated by reference.

### BACKGROUND OF THE INVENTION

1. Field of the Invention

The present invention relates to electronic communication systems. More particularly, the present invention relates to an input function supporting method and apparatus that switches an input mode in a touchscreen-based mobile device via a function key when a touch interface malfunctions, so that the touchscreen-based device can be operated in the switched input mode by the function keys.

2. Description of the Related Art

With the rapid development of information and communication technology and semiconductor technology, the use of various types of mobile devices has also increased. The trend in mobile devices is the convergence of service functions that were historically provided by a plurality of types of mobile devices. For example, mobile communication devices now have functions in addition to their traditional communication functions such as a voice call, and message transmission and reception. Examples of the additional functions are a Television (TV) viewing function (e.g., mobile broadcasting, such as Digital Multimedia Broadcasting (DMB), Digital Video Broadcasting (DVB), etc.), an audio playback function (e.g., Moving Picture Experts Group (MPEG)-1 or MPEG-2 Audio Layer 3 (MP3)), a photographing function, an Internet access function, dictionary search function, etc.

In recent years, most mobile devices have been equipped with a touch screen that can serve as a display unit for displaying various types of information and an input unit for receiving data, etc. These touchscreen-based mobile devices are implemented in such a manner that the touchscreen is a full touchscreen type. The touchscreen-based mobile devices may not include physical alpha-numeric keys, etc. In this case, the touchscreen-based mobile devices allow users to touch the touch interface to input alpha-numeric data. Touchscreen-based mobile devices of the related art are disadvantageous in that, when the touch interface for supporting the touch input malfunctions, they cannot be operated.

Although touchscreen-based mobile devices of the related art include a volume key, a send key, a home key, an end key, and a hold key, these keys only allow for simple functions assigned thereto, respectively. For example, the keys only support functions pre-assigned thereto, respectively, such as, a volume control, a camera function execution, etc. In addition, if the touch interface of a touchscreen-based mobile device malfunctions and the touchscreen-based mobile device enters a particular mode according to the operation of a particular key, the touchscreen-based mobile devices cannot be controlled to perform a corresponding function in that mode. That is, when the touch interfaces of the touchscreen-based mobile devices malfunction, they cannot perform touch-based operations, such as an activation of a particular menu, a selection of an icon assigned to a particular function, an execution of the function, etc.

### SUMMARY OF THE INVENTION

Aspects of the present invention are to address at least the above mentioned problems and/or disadvantages and to provide at least the advantages described below. Accordingly, an aspect of the present invention is to provide a method and apparatus for supporting an input function as a substitute for a touch function when a touch interface of a touchscreen-based device malfunctions.

Another aspect of the invention is to provide an optimal user interface environment where a touchscreen-based mobile device can be operated via mechanical input buttons when the touch interface malfunctions.

Another aspect of the invention is to provide an apparatus and method that enters, when the touch interface of a touchscreen-based mobile device malfunctions, an emergency input mode by the operation of mechanical function keys, and controls the touchscreen-based mobile device according to signals created as the function keys are operated in the emergency input mode.

Another aspect of the invention is to provide a touchscreen-based mobile device that can support an input function as a substitute for a touch-based input function when the touch interface malfunctions, thereby enhancing user convenience and access to the touchscreen-based mobile device.

In accordance with an aspect of the present invention, a method for supporting an input function in a touchscreen-based device when the touch interface malfunctions is provided. The method includes detecting an input operation via a function key, determining, when the input operation is performed via the function key, an input manner of the input operation via the function key, changing, when the input manner of the input operation via the function key corresponds to a preset manner, a current mode to an emergency input mode, and processing a function, according to another input operation of the same or another function key, in the emergency input mode.

Preferably, the method may be implemented with programs that can execute the processes, which are stored in a computer-readable recording media.

In accordance with another aspect of the present invention, a touchscreen-based device that supports an input function when the touch interface malfunctions is provided. The device includes a display unit, an input unit, and a controller. The display unit displays screen data in a normal mode or an emergency input mode. The input unit provides an input signal to enter an emergency input mode according to an input manner of a main function key. The input unit includes a number of function keys for supporting an input function according to modes of the touchscreen-based mobile device. The controller detects an input operation of the main function key. The controller determines an input manner of the main function key. The controller controls whether to enter the emergency input mode according to the input manner. The controller controls a function of one or more of the function keys in the emergency input mode.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will become more apparent from the following description taken in conjunction with the accompanying drawings, in which:

FIG. 1 illustrates a schematic block diagram of a touchscreen-based mobile device according to an exemplary embodiment of the present invention;

FIG. 2 illustrates an appearance of a touchscreen-based mobile device according to an exemplary embodiment of the present invention;

FIGS. 3 and 4 illustrate screens showing when a touchscreen-based mobile device enters an emergency input mode, according to an exemplary embodiment of the present invention; and

FIG. 5 is a flowchart that describes a method for supporting an input function when a touch interface of a touchscreen-based mobile device malfunctions, according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention relate to an apparatus and method that can support an input function using given function keys when a touchscreen-based mobile device's touch interface malfunctions so that its functions cannot be controlled by a touch operation. When the touch interface of a touchscreen-based mobile device malfunctions, the apparatus and method according to exemplary embodiments of the present invention can allow the touchscreen-based mobile device to enter an emergency input mode according to the operation of a given function key. In the emergency input mode, the touchscreen-based mobile device can be controlled by operating given function keys. Therefore, although a touchscreen-based mobile device's touch interface malfunctions, the apparatus and method according to exemplary embodiments of the present invention can allow a user to easily use the touchscreen-based mobile device.

In the following description of exemplary embodiments of the present invention, it should be understood that the touch interface corresponds to a touch screen and they are differentiated for the sake of convenience in description. The emergency input mode refers to a mode to which a current mode is switched by a user's function key operation when the touch interface of a touchscreen-based mobile device malfunctions. In the emergency input mode, function keys can create input signals to perform other functions as well as their originally assigned functions, respectively. In addition, in the emergency input mode, the screen configuration on the display unit may differ from that in the normal mode provided when the touch interface is operating normally.

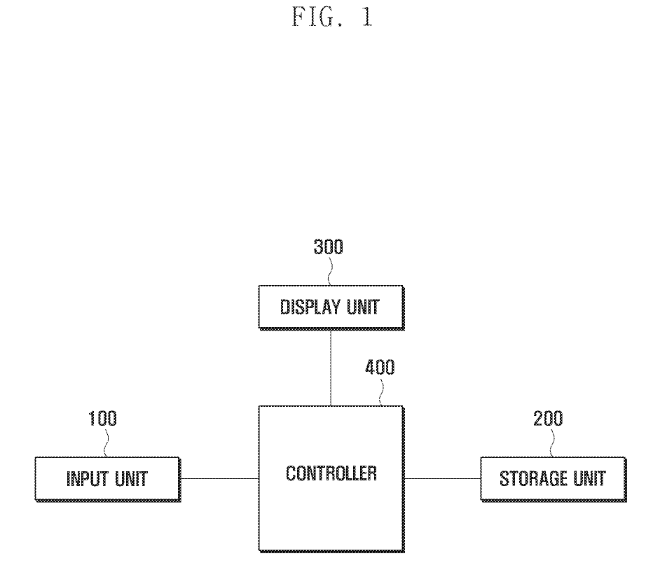

In the following description, the configuration of a touchscreen-based mobile device and a method for controlling the device are explained in detail referring to FIGS. 1 to 5. It should be understood that the present invention is not limited to the following exemplary embodiments. It will be noted that there may be many modifications from the exemplary embodiments.

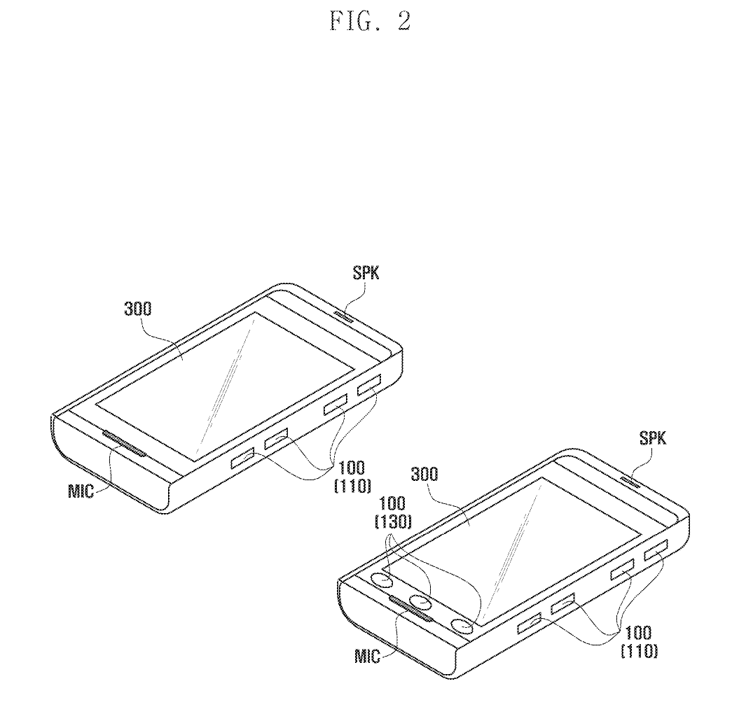

FIG. 1 illustrates a schematic block diagram of a touchscreen-based mobile device according to an exemplary embodiment of the present invention, and FIG. 2 illustrates the appearance of the touchscreen-based mobile device according to an exemplary embodiment of the present invention.

Referring to FIGS. 1 and 2, the touchscreen-based mobile device includes an input unit 100, a storage unit 200, a display unit 300, and a controller 400.

It should be understood that the touchscreen-based mobile device may further include the following components according to its functions: a Radio Frequency (RF) communication unit for performing wireless communication; an audio processing unit with a microphone (MIC) and a speaker (SPK); a digital broadcasting module for receiving and reproducing digital broadcasts (e.g., mobile broadcasts such as Digital Multimedia Broadcasting (DMB), Digital Video Broadcasting (DVB), etc.); a camera module for photographing pictures/motion pictures; a Bluetooth communication module for performing Bluetooth communication, an Internet communication module for performing an Internet communication function; a touchpad for receiving a touch-based input; etc. In this disclosure, a detailed description of these components is omitted for brevity.

The input unit 100 detects a user's operations, creates input signals corresponding thereto, and transfers them to the controller 400. The input unit 100 may include a number of function keys. More particularly, the input unit 100 includes one or more function keys that activate an emergency input mode and create input signals for controlling the touchscreen-based mobile device in the emergency input mode. For example, as shown in FIG. 2, the touchscreen-based mobile device includes at least one function key (e.g., 110 and 130) on the front and/or the side, according to the type of display unit 300 (e.g., a full touch screen type).

The storage unit 200 stores application programs related to the touchscreen-based mobile device and data processed therein. The storage unit 200 may be comprised of at least one or more volatile memory devices and non-volatile memory devices. For example, the storage unit 200 can permanently or temporarily store an operating system of the touchscreen-based mobile device, data and programs related to the display control operations of the display unit 300, data and programs related to the input control operations using the display unit 300, data and programs related to the execution and the operations of an emergency input mode, data and programs related to the input control operations of the input unit 100 in the emergency input mode, etc. The storage unit 200 can also store, in a table, function information, including function keys mapped to functions respectively, in a normal mode and an emergency input mode. An example of the mapping table is shown in the following Table 1.

TABLE 1

| Function Key | Normal Mode | Emergency input mode |
|---|---|---|
| Volume up key | Volume up | Move between items (in the |
| | | forward direction) |
| Volume down | Volume down | Move between items (in the |
| key | | backward direction) |
| Home key | Input manner 1: Selection, | Execute item |
| | Confirmation | |
| | Input manner 2: Switch | |
| | to emergency input | |
| | mode when an input is | |
| | performed in a preset | |
| | manner | |
| Shortcut key | Execute a mapped | Input manner 1: execute a |
| (Camera, etc.) | shortcut key function | mapped shortcut key function |
| | (Camera function, etc.) | Input manner 2: terminate the |
| | | emergency input mode |

As described in Table 1, it is assumed that the input unit 100 includes a number of function keys, such as a volume up key, a volume down key, a home key, a shortcut key, etc. The functions may be assigned to the function keys according to a user's settings or a mobile device manufacturer's settings. The functions executed by the function keys are mapped to modes such as a normal mode and an emergency input mode, respectively. For example, when the user operates a volume up key in a normal mode, the touchscreen-based mobile device extracts information regarding a function corresponding to the volume up key in the normal mode from the table, and then executes a volume up function. In addition, when the user operates a volume up key in an emergency input mode, the touchscreen-based mobile device extracts information regarding a function corresponding to the volume up key in the emergency input mode from the table, and then executes a focus movement function between items (e.g., in the forward direction).

More particularly, as shown in Table 1, when an input corresponding to a home key is created in the normal mode, the touchscreen-based mobile device determines its input manner. When the touchscreen-based mobile device ascertains that an input operation is performed in a normal manner (e.g., input manner 1 where an input operation is performed once), it performs a function according to an item selection or a confirmation. On the contrary, when the touchscreen-based mobile device ascertains that an input operation is performed in a preset manner (e.g., input manner 2), it performs an emergency input mode. In an exemplary embodiment of the present invention, the input manner 2 refers to an input operation performed in such a manner that a home key is pressed for a relatively long period of time or repeatedly pressed a certain number of times.

The display unit 300 provides screens according to the execution of applications of the touchscreen-based mobile device. The applications refer to programs for executing a variety of functions, such as message, email, Internet function, multimedia function, search, communication, electronic book (e-book) function, picture/motion picture photographing and viewing functions, TV viewing function (e.g., mobile broadcasts, such as DMB, DVB, etc.), audio file playback (e.g., Moving Picture Experts Group (MPEG)-1 or MPEG-2 Audio Layer 3 (MP3)), widget function, emergency input mode function, etc. The display unit 300 may be implemented with a Liquid Crystal Display (LCD), an Organic Light Emitting Diode (OLED), an Active Matrix OLED (AMOLED), or the like. The display unit 300 may display screen data in a landscape or portrait mode.

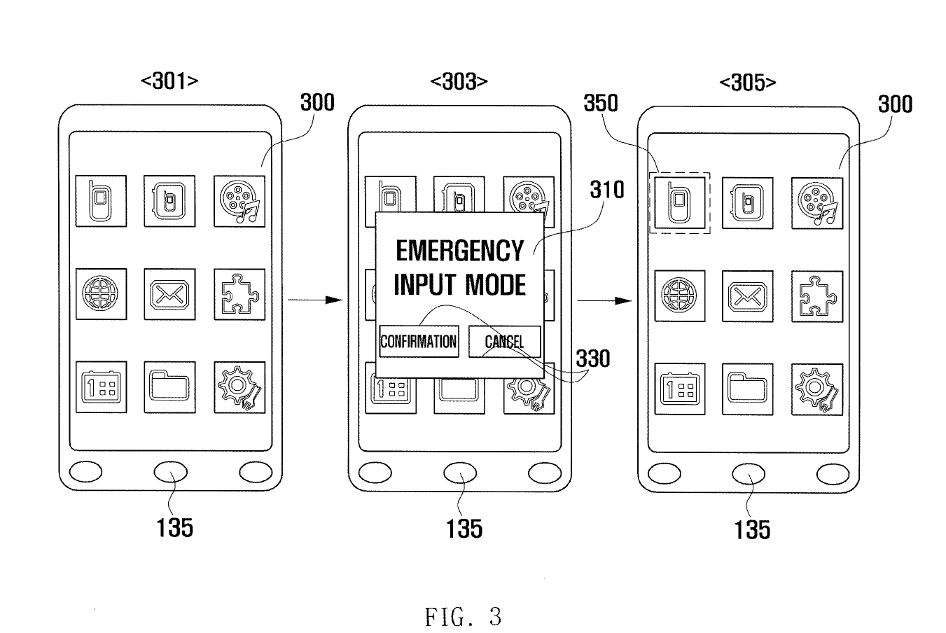

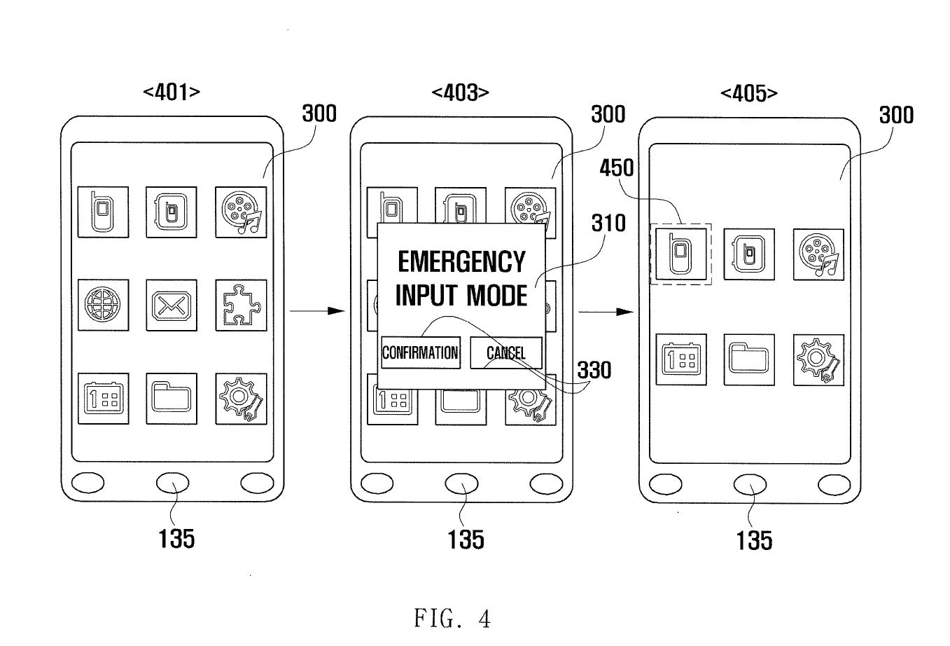

The display unit 300 may be implemented with a touch input unit (not shown), such as a touch interface based on a touch screen. In that case, the display unit 300 receives a touch-based input, creates an input signal corresponding thereto (e.g., a touch signal), and transfers it to the controller 400. The display unit 300 displays a screen according to the execution of an emergency input mode, i.e., an emergency input mode screen. The execution of an emergency input mode will be described in more detail later, referring to FIGS. 3 and 4.

The controller 400 controls the entire operation of the mobile device. The controller 400 controls the functions in the emergency input mode. For example, when the controller 400 detects an input in a preset manner via a particular function key of the input unit 100, it can execute an emergency input mode. When the controller 400 executes an emergency input mode, it can output a pop-up message window asking the user whether to enter the emergency input mode. The controller 400 can control the function according to the operation of the function key in the emergency input mode. The controller 400 can process the functions assigned to the function keys according to the normal mode and the emergency input mode as described in Table 1.

The controller 400 can provide screen data to configure a user interface in the emergency input mode, which differs from that in the normal mode. For example, when the controller 400 enters an emergency input mode, it changes a user interface (screen data) displayed in a normal mode into a user interface optimally configured in the emergency input mode. In addition, when the controller 400 enters an emergency input mode, it activates the periphery of one of the items in the user interface, in an executing standby state, and displays it. The controller 400 moves and displays the activation state (e.g., focus) of an item according to the operation of a function key. The operation according to the entrance of the emergency input mode will be described in more detail later, referring to FIGS. 3 and 4. In addition, the operation of the controller 400 will also be explained later.

The controller 400 also controls operations related to the general functions of the touchscreen-based mobile device. For example, when the controller 400 executes an application, it can also control the display of data related to the execution of the application. The controller 400 can also switch a normal mode to an emergency input mode or vice versa. The controller 400 can execute a function corresponding to an item, selected according to the operation of a function key of the input unit 100, in the emergency input mode and can display screen data according to the execution of the function.

As shown in FIGS. 1 and 2, exemplary embodiments of the present invention can be applied to all types of mobile devices. The touchscreen-based mobile device according to exemplary embodiments of the present invention include all information communication devices, multimedia devices, and their applications, which are operated according to communication protocols corresponding to a variety of communication systems. For example, the touchscreen-based mobile device can be applied to mobile communication terminals, Portable Multimedia Players (PMPs), digital broadcast players, Personal Digital Assistants (PDAs), audio players (e.g., MP3 players), mobile game players, smart phones, etc.

In addition, the method according to exemplary embodiments of the present invention can execute an emergency input mode via a function key and also control functions via the function keys in the emergency input mode. This method can be adapted to televisions, Large Format Displays (LFDs), Digital Signages (DSs), media poles, etc.

FIG. 3 illustrates an example of screens showing when a touchscreen-based mobile device enters an emergency input mode, according to an exemplary embodiment of the present invention.

Referring to FIG. 3, as shown in diagram 301, it is assumed that the display unit 300 displays screen data comprised of a number of items. It is also assumed that the touch interface of the display unit 300 cannot receive an input, i.e., the touch interface has malfunctioned. In an exemplary embodiment of the present invention, the screen data is provided with an idle screen in an idle mode, with a screen in an application mode where a particular application is executed, or with a screen in a turn-off mode where the display unit 300 is turned off.

When one of the function keys in the input unit 100, for example, a function key 135, is operated in a preset manner while the display unit 300 is displaying the screen as shown in diagram 301, the touchscreen-based mobile device enters an emergency input mode. For example, the user presses the function key 135 for more than a preset period of time (e.g., 3 seconds), thereby executing the emergency input mode. Alternatively, the user repeatedly presses the function key 135 more than a preset number of times (e.g., 5 times), thereby executing the emergency input mode.

When the particular function key is operated in a preset manner as described above, the display unit 300 displays a pop-up message window to allow the user to select whether to enter an emergency input mode. For example, as shown in diagram 303, a pop-up message window 310 appears on the display unit 300, asking the user whether to enter an emergency input mode with command button items “Confirmation” and “Cancel.” In that case, the user can decide whether to enter an emergency input mode by selecting one of the command button items 330 on the pop-up message window 310. For example, the user selects and activates a command button item “Confirmation” or “Cancel” by operating the volume up/down key, and then executes the selected item via a home key (e.g., the function key 135), thereby determining whether to enter an emergency input mode. Although the exemplary embodiment of the present invention is implemented in such a manner to include determining whether to enter an emergency input mode as shown in diagram 303, it may be modified not to include this step according to the settings. For example, when an input is created in an input manner using the function key 135 in a state where the touchscreen-based mobile device displays the screen on the display unit 300 as shown in diagram 301, the touchscreen-based mobile device may omit the state shown in diagram 303 and directly proceed to the state shown in diagram 305.

Meanwhile, it is assumed that the user has decided to enter an emergency input mode on the screen as shown in diagram 303. For example, when the user selects “Confirmation” of the command button items 330 on the pop-up message window 310 by operating a function key (e.g., a volume up/down key, a home key, etc.), the touchscreen-based mobile device executes an emergency input mode and displays corresponding screen data. As shown in diagram 305, the touchscreen-based mobile device locates a focus on a particular item (e.g., item 350 at top left) in the screen data, and shows that it is in an activated state.

Activation of a particular item allows a user to easily and intuitively recognize that a function corresponding to the item can be executed when he/she selects the item. That is, activation of a particular item can be achieved in such a manner that the periphery of the item in an execution waiting state is activated. In addition, the focus is moved to an item according to the operation of a function key (e.g., a volume up/down key), thereby activating the item. Although screen data shown in diagram 305 is identical to screen data that can be operated via the touch interface, shown in diagram 301, the screen data shown in the emergency input mode between the screens 305 and 301 is different. In the emergency input mode, the items in an execution waiting state are activated and the focus can be moved between items by operating a volume up/down key, etc.

FIG. 4 illustrates another example of screens showing when a touchscreen-based mobile device enters an emergency input mode, according to an exemplary embodiment of the present invention.

Referring to FIG. 4, as shown in diagram 401, it is assumed that the display unit 300 displays screen data comprised of a number of items. It is also assumed that the touch interface of the display unit 300 cannot receive an input, i.e., the touch interface malfunctions. In an exemplary embodiment of the present invention, the screen data is provided with an idle screen in an idle mode, with a screen in an application mode where a particular application is executed, or with a screen in a turn-off mode where the display unit 300 is turned off.

When a particular function key in the input unit 100, for example, a function key 135, is operated in a preset manner while the display unit 300 is displaying the screen as shown in diagram 401, the touchscreen-based mobile device enters an emergency input mode. For example, the user presses the function key 135 for more than a preset period of time (e.g., 3 seconds), thereby executing the emergency input mode. Alternatively, the user repeatedly presses the function key 135 more than a preset number of times (e.g., 5 times), thereby executing the emergency input mode.

When the particular function key is operated in a preset manner as described above, the display unit 300 displays a pop-up message window 310 asking the user whether to enter an emergency input mode, as shown in diagram 403. Since the pop-up message window 310 has already been described in the part explaining the exemplary embodiment referring to FIG. 3, its detailed description is omitted for conciseness in description. In addition, as described above with reference to FIG. 3, the exemplary embodiment of FIG. 4 may also be modified not to include the step of determining whether to enter an emergency input mode according to the settings.

Meanwhile, it is assumed that the user has decided to enter an emergency input mode on the screen as shown in diagram 403. For example, when the user selects “Confirmation” of the command button items 330 on the pop-up message window 310 by operating a function key (e.g., a volume up/down key, a home key, etc.), the touchscreen-based mobile device executes an emergency input mode and displays corresponding screen data. For example, as shown in diagram 405, the touchscreen-based mobile device displays screen data that differs from that as shown in diagram 401. That is, the screen data shown in diagram 405 may be comprised of items that can be operated by function keys for the sake of user convenience. In addition, the touchscreen-based mobile device also locates a focus on a particular item (e.g., the item 450 at top left) in the screen data shown in diagram 405, and shows that it is in an activated state.

Activation of a particular item allows a user to easily and intuitively recognize that a function corresponding to the item can be executed when he/she selects the item. That is, activation of a particular item can be achieved in such a manner that the periphery of the item in an execution waiting state is activated. In addition, a focus is moved to an item according to the operation of a function key (e.g., a volume up/down key), thereby activating the item.

As described in the exemplary embodiments referring to FIGS. 1 to 4, the input function supporting method and apparatus according to exemplary embodiments of the present invention can switch a touch input mode to an emergency input mode by operating a function key, even when the touchscreen-based mobile device's touch interface malfunctions. In the emergency input mode, the operation of function keys makes it possible to control a dialing function, a selection of a shortcut dialing button, execution of a particular function, etc. For example, an item for executing a dialing function is selected from among items included in the screen data by operating a function key, thereby performing a dialing function. When the dialing function is executed, a virtual keypad is activated on the dialing execution screen. After that, the user operates a volume up/down and a home key to select a number to be dialed on the virtual keypad. After selecting and inputting all digits (e.g., a phone number), the user can select a call button on the virtual keypad by operating the volume up/down and the home key, thereby performing a dialing function.

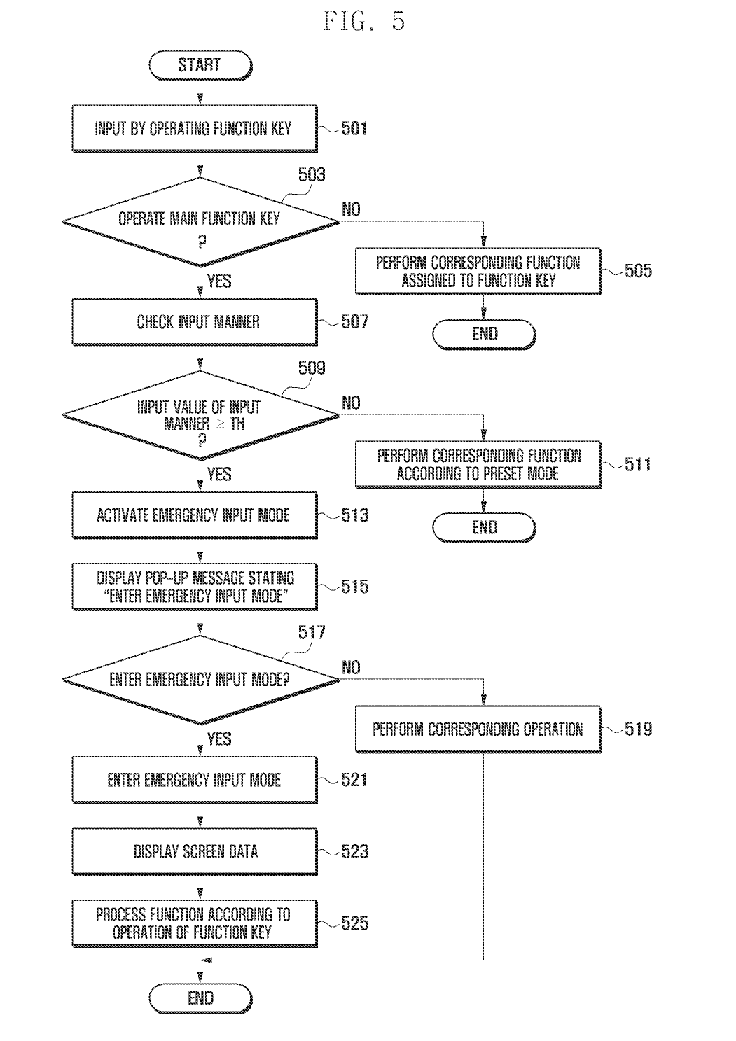

FIG. 5 is a flowchart that describes a method for supporting an input function when a touch interface of a touchscreen-based mobile device malfunctions, according to an exemplary embodiment of the present invention.

Referring to FIG. 5, the controller 400 detects an input according to the operation of a function key in step 501). For example, while the controller 400 is controlling one of an idle mode where an idle screen is displayed, an application mode where a screen is displayed according to the execution of a particular application (e.g., corresponding to a camera function, etc.), and a turn-off mode where the display unit 300 is turned off, the controller 400 can receive an input signal created by a function key.

When the controller 400 has detected the input operation of the function key at step 501, the controller 400 in step 503 determines whether the detected function key is a particular function key related to the execution of an emergency input mode, for example, a home key, which is hereinafter referred to as a ‘main function key’. It should be understood that the term ‘main function key’ is used herein merely for the sake of convenience in description.

When the controller 400 ascertains that the detected function key is not a main function key at step 503, the controller 400 controls the execution of a function originally assigned to the detected function key in step 505. For example, when the controller 400 ascertains that the detected function key is a volume up key, the controller 400 increases the volume of the touchscreen-based mobile device according to the inputting operation of the volume up key. In addition, when the controller 400 ascertains that the detected function key is a camera function shortcut key, the controller 400 controls the function of the camera module according to the inputting operation of the camera function shortcut key.

On the contrary, when the controller 400 ascertains that the detected function key is a main function key at step 503, the controller 400 determines the input manner of the main function key in step 507. After that, the controller 400 determines whether the input value of the input manner is equal to or greater than a preset value TH in step 509. For example, when the input manner is a repetitive input manner, the controller 400 determines whether the main function key is input a preset number of times. Alternatively, when the input manner is a time input manner, the controller 400 determines whether the main function key is input for at least a preset period of time.

When the controller 400 determines that the input value of the input manner (e.g., once or less than 3 seconds) is less than a preset value TH at step 509, it controls a corresponding function according to a preset mode in step 511. For example, the controller 400 ignores the input of the main function key or performs a function originally assigned to the main function key.

On the contrary, when the controller 400 determines that the input value of the input manner (e.g., 5 times or longer than 3 seconds) is equal to or greater than a preset value TH at step 509, the controller 400 activates an emergency input mode in step 513. After that, the controller 400 displays a pop-up message window to allow the user to determine whether to enter an emergency input mode in step 515. For example, as described in the parts referring to FIGS. 3 and 4, the controller 400 can display a pop-up message window 310 with command button items 330.

After displaying the pop-up message window 310 at step 515, the controller 400 determines whether a request is made to enter an emergency input mode in step 517. For example, as described in the parts referring to FIGS. 3 and 4, when a command button item “Confirmation” or “Cancel” is selected in the pop-up message window 310 by operating a function key, the controller 400 detects the selected item and determines whether to enter an emergency input mode.

When the controller 400 determines that a request is not made to enter an emergency input mode at step 517, the controller 400 performs a corresponding operation in step 519. For example, when the controller 400 ascertains that a “Cancel” command button item is selected, the controller 400 removes the displayed pop-up message window 310 and then displays previously displayed screen data.

On the contrary, when the controller 400 determines that a request is made to enter an emergency input mode at step 517, the controller 400 enters an emergency input mode in step 521. After that, the controller 400 displays screen data in the emergency input mode in step 523. For example, as described in the parts referring to FIGS. 3 and 4, the controller 400 highlights and displays a particular item in an execution waiting state. Alternatively, the controller 400 controls the display of screen data comprised of only items that can be controlled by the function keys.

After that, the controller 400 executes and processes a function by an item that is selected in the screen data by operating the function key in step 525. For example, when the user selects a particular item by operating the function key to activate the particular item in an execution waiting state, and then executes the particular item, the controller 400 can execute the function corresponding to the particular item.

As described above, the input function supporting method and apparatus, according to exemplary embodiments of the invention, can switch from a current mode into an emergency input mode when the touch interface of the touchscreen-based mobile device malfunctions, and can support an input function in the emergency input mode by operating function keys. The input function providing method and apparatus can be implemented with program commands that can be executed via various types of computers and recorded in computer-readable recording media. The computer-readable recording media contains program commands, data files, data structures, or the like, or a combination thereof. The program commands recorded in the recording media may be designed or configured to comply with the exemplary embodiments of the present invention or may be software well-known to the ordinary person skilled in the art.

The computer-readable recoding media includes hardware systems for storing and conducting program commands. Examples of the hardware systems are magnetic media such as a hard disk, floppy disk, a magnetic tape, optical media such as Compact Disc Read-Only Memory (CD-ROM) and Digital Versatile Disc (DVD), Magneto-Optical Media, such as floptical disk, Read-Only Memory (ROM), Random-Access Memory (RAM), flash memory, etc. The program commands include assembly language or machine code complied by a complier and a higher level language interpreted by an interpreter. The hardware systems may be implemented with at least one software module to comply with the exemplary embodiments of the present invention.

As described above, the input function supporting apparatus and method, according to exemplary embodiments of the present invention, can support an input function as a substitute for a touch input function when a touch interface of a touchscreen-based device malfunctions. When the touchscreen-based mobile device's touch interface malfunctions due to damage of a chipset in the touch screen, touch panel damage, etc., the input function supporting apparatus and method can support an input function as a substitute for a touch input function of the touch interface, using given function keys.

In addition, when a touch input function cannot be performed in the touchscreen-based mobile device, the touch input mode can be switched to an input mode by using a function key, so that the touchscreen-based mobile device can be controlled in the switched input mode by using the function keys. Therefore, although the touchscreen-based mobile device's touch interface malfunctions, the input function supporting apparatus and method can reduce the use inconvenience of the device. That is, the input function supporting apparatus and method can allow a user to use essential functions of the touchscreen-based mobile device by using function keys even in a state where the touch input function cannot be performed, thereby enhancing user convenience, accessibility, and competiveness.

While the invention has been shown and described with reference to certain exemplary embodiments thereof, it will be understood by those skilled in the art that various changes in form and details may be made therein without departing from the spirit and scope of the invention as defined in the appended claims and their equivalents.

What is claimed is:

1. A method for supporting an input function in a touchscreen-based device when the touch interface malfunctions, the method comprising:
detecting an input operation via a function key;
determining, when the input operation is performed via the function key, an input manner of the input operation via the function key;
changing, when the input manner of the input operation via the function key corresponds to a preset manner, a current mode to an emergency input mode; and
processing a function, according to another input operation of the same or another function key, in the emergency input mode.

2. The method of claim 1, wherein the function key for which the input operation is detected is a main function key among a plurality of function keys.

3. The method of claim 1, wherein the changing comprises:
displaying, when the input manner of the input operation via the function key corresponds to the preset manner, screen data according to the emergency input mode.

4. The method of claim 3, wherein the screen data according to the emergency input mode comprises the same screen data that was displayed before entering the emergency input mode but with a focus on one item of the screen data.

5. The method of claim 3, wherein the screen data according to the emergency input mode is differentiated from screen data displayed before entering the emergency input mode and includes a focus on one item of the screen data.

6. The method of claim 1, wherein the changing comprises:
displaying, when the input manner of the input operation via the function key corresponds to the preset manner, a pop-up message asking a user whether to enter an emergency input mode;
determining whether to enter an emergency input mode based on a command button item in the pop-up message being selected via another input operation via the same or another function key; and
entering, when it is determined to enter the emergency input mode, the emergency input mode.

7. The method of claim 6, wherein the changing further comprises:
displaying, when entering the emergency input mode, screen data according to the emergency input mode.

8. The method of claim 7, wherein the displaying of the screen data comprises:
differentiating the screen data according to the emergency input mode from screen data displayed before entering the emergency input mode; and
displaying the differentiated screen data with a focus on one item of the differentiated screen data.

9. The method of claim 7, wherein the displaying of the screen data comprises displaying the same screen data that was displayed before entering the emergency input mode but with a focus on one item of the screen data.

10. The method of claim 6, wherein the determining of whether to enter an emergency input mode comprises:
determining whether the other input operation of the same or other function key is performed for more than a preset period of time.

11. The method of claim 6, wherein the determining of whether to enter an emergency input mode comprises:
determining whether the other input operation of the same or other function key is performed more than a preset number of times.

12. The method of claim 1, wherein the detecting of the input operation comprises:
detecting the input operation of the function key while operating in one of an idle mode where an idle screen is displayed, an application mode where a screen is displayed according to the execution of a particular application, and a turn-off mode where the display unit is turned off.

13. A touchscreen-based device that supports an input function when the touch interface malfunctions, the device comprising:
a display unit for displaying screen data in a normal mode or an emergency input mode;
an input unit for providing an input signal to enter an emergency input mode according to an input manner of a main function key, the input unit including a number of function keys for supporting an input function according to modes of the device; and
a controller for detecting an input operation of the main function key, for determining an input manner of the input operation via the main function key, for controlling whether to enter the emergency input mode according to the input manner, and for controlling a function of one or more of the function keys in the emergency input mode.

14. The device of claim 13, wherein the controller controls a pop-up message to be displayed when the input manner of the input operation via the main function key corresponds to a preset manner, and determines whether to enter the emergency input mode based on a command button item in the pop-up message being selected via another input operation via one of the function keys.

15. The device of claim 14, wherein the controller determines to control the pop-up message to be displayed when the input operation of the main function key is performed for more than a preset period of time in one of an idle mode where an idle screen is displayed, an application mode where a screen is displayed according to the execution of a particular application, and a turn-off mode where the display unit is turned off.

16. The device of claim 14, wherein the controller determines to control the pop-up message to be displayed when the input operation of the main function key is performed more than a preset number of times in one of an idle mode where an idle screen is displayed, an application mode where a screen is displayed according to the execution of a particular application, and a turn-off mode where the display unit is turned off.

17. The device of claim 14, wherein, when entering the emergency input mode, the controller changes screen data displayed on the display unit to screen data corresponding to the emergency input mode and displays the screen data corresponding to the emergency input mode.
